(19) United States
(12) Patent Application Publication
(10) Pub. No.: US 2026/0159177 A1
(43) Pub. Date: Jun. 11, 2026

(54) INTERIOR PART CONNECTION

(71) Applicant: FCA US LLC, Auburn Hills, MI (US)

(72) Inventors: Ying Pauline Wu, Shanghai (CN); Wei Fang, Shanghai (CN); Zhongyun Feng, Shanghai (CN); Xuezhong Fu, Shanghai (CN)

(21) Appl. No.: 18/973,484

(22) Filed: Dec. 9, 2024

(51) Int. Cl. B62D 25/14; B62D 65/14

(52) U.S. Cl. CPC B62D 25/14; B62D 65/14

(57) ABSTRACT

A vehicle interior assembly has a dashboard framework with a receiving opening with two sidewalls. The opening includes a pair of guide grooves, one groove on each side of the opening. A console framework has a basket with a pair of sidewalls, a pair of guide surfaces with one guide surface projecting from each sidewall. The guide surfaces are received in the guide grooves to engage the basket in the opening to be received by the dashboard framework. Guide pins, coupled with the basket, engage the apertures in the dashboard framework.

### CROSS-REFERENCE TO RELATED APPLICATION

The present application is related in general subject matter to pending United States Patent Application Serial No. ________ (Attorney Docket No. 712619US1), filed concurrently herewith, entitled “Interior Part With A Table,” assigned to FCA US LLC, and hereby incorporated by reference in its entirety into the present application.

### FIELD

The present disclosure relates to vehicles and, more particularly, to a vehicle connection between a dashboard and a console.

### BACKGROUND

This section provides background information related to the present disclosure which is not necessarily prior art.

In automobile vehicles, the interiors generally include a dashboard as well as a console between the seats. More and more vehicles are connecting the console with the dashboard. Thus, there is a need for a connection between the dashboard and the console.

Various types of connections exist for connecting the dashboard framework with the console framework. The connections can include fasteners, such as bolts and screws, as well as clips to connect the dashboard with the console. However, sometimes connections are difficult due to the ability to get a solid connection between the two parts.

The present disclosure provides a connection between the dashboard framework and the console framework. The present disclosure provides a connection where a blind view of the connection exists between the two parts. The present disclosure enables the console to be inserted into the dashboard and then placed into position in the vehicle with minimal visible connections.

### SUMMARY

This section provides a general summary of the disclosure, and is not a comprehensive disclosure of its full scope or all of its features.

According to the present disclosure, a vehicle interior assembly comprises a dashboard framework having a receiving opening with two sidewalls. A pair of guide grooves, one groove on each side of the opening in the walls, receive the console. A console framework has a basket with a pair of sidewalls. A pair of guide surfaces project from each sidewall of the basket. The guide surfaces are received by the guide grooves, engaging the basket, to be received in the opening. Guide pins are coupled with the basket to engage apertures in the dashboard framework. A pair of stops, one each adjacent the basket guide surfaces, contact the dashboard framework to terminate insertion of the basket into the receiving opening. The guide pins project from each stop. A flange projects from each side of the opening to receive a base of the basket. One of the guide pins is on a front wall of the basket to position the basket in the opening. The basket is rotated for adjustment purposes, so the guide pins can engaged into the aperture on the dashboard framework.

A method of connecting a dashboard and console including the above features comprises the steps of aligning the console guide surfaces in the dashboard guide grooves. The console guide surfaces are partially inserted into the guide grooves. The console is rotated to align the guide pins. The console basket is further inserted into the dashboard receiving openings. Further, the guide pins are inserted into the apertures. The stops contact against the dashboard framework. The console is rotated downward into its designed position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of the interior assembly.

FIG. 2 is a schematic view of the dashboard framework.

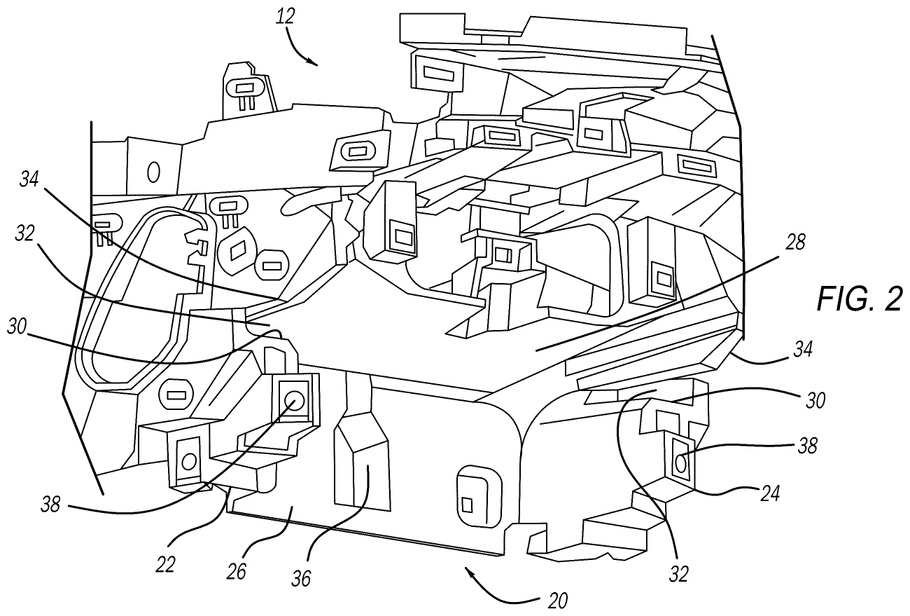

FIG. 3 is a perspective view of the console.

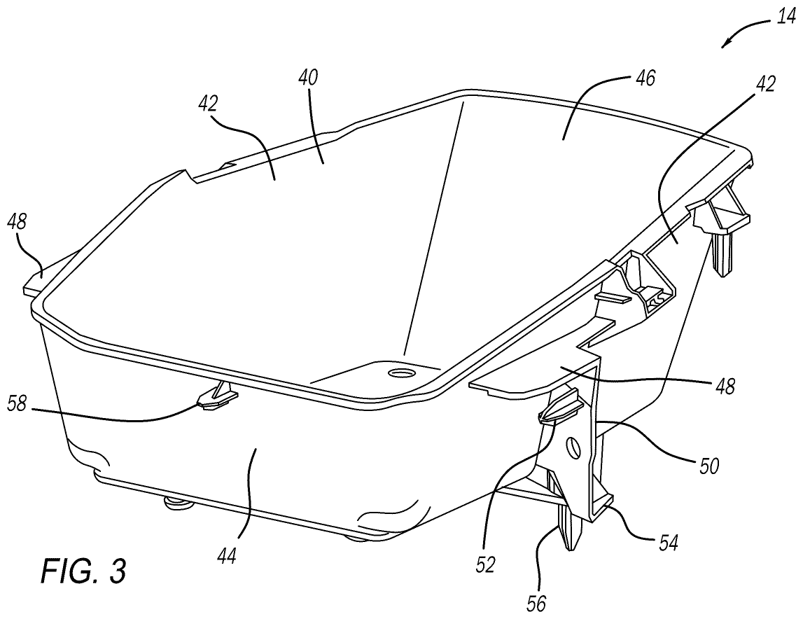

FIG. 4 is a schematic view of insertion of the console into the dashboard.

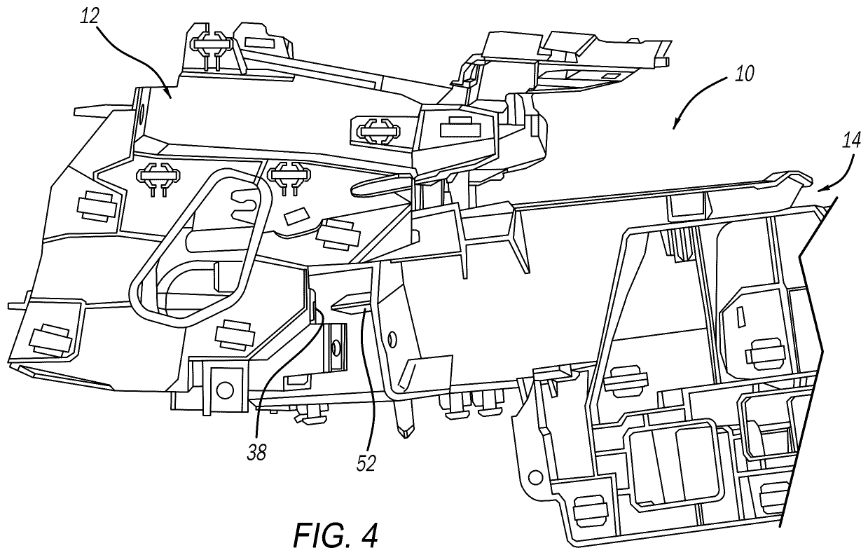

Corresponding reference numerals indicate corresponding parts throughout the several views of the drawings.

### DETAILED DESCRIPTION

Example embodiments will now be described more fully with reference to the accompanying drawings.

Turning to the figures, an interior assembly is illustrated and designated with the reference numeral 10. The interior assembly 10 includes a dashboard framework 12 and a console framework 14. The console framework 14 is inserted into the dashboard framework 12 and is coupled with the floor board in its designated position.

The dashboard framework 12 includes a console receiving opening 20 having a pair of sidewalls 22, 24 as well as a rear wall 26 defining the opening. The opening 20 also includes a roof 28 to limit the opening.

The walls 22, 24 have a ledge 30 defining a guide groove 32. The guide grooves 32 receive the console framework 14 as will be explained later. Also, a guide surface 34 projects from the roof 28 to limit the guide grooves 32 to enable insertion of the console framework 14 into the opening 20. Also, the back wall 26 includes a recess 36 to receive a console middle guide pin 58. The walls 22, 24 include apertures 38 that receive stop pins 52 as will be discussed later.

The console 14 includes a basket 40 defined by sidewalls 42, front wall 44 as well as rear wall 46. The sidewalls 42 include projecting guide surfaces 48 that mate the guide grooves 32. The guide surfaces 48 are a substantially planar flange that fits into the guide grooves 32. A stop 50 projects downward from the guide surfaces 48. The stop 50 is substantially perpendicular to the guide surfaces 48. The stop 50 includes a pin 52 that projects into the aperture 38 of the walls 22, 24. The stop 50 also includes a flange 54 that includes a second pin 56 that positions the console framework 14 with respect to the floor board. The middle guide pin 58 projects from the front wall 44 to insert into the recess 36 on the dashboard framework front wall 26 of the opening 20. The middle guide pin 58 centers the console framework 14 upon insertion into the recess 36.

When an assembly worker is connecting the console framework 14 with the dashboard framework 12, he is not always capable of seeing the opening 20 for inserting the console basket 40 into the dashboard opening 20. The assembly worker can see the opening 20 but not necessarily see the guide groove 32 connections.

Accordingly, when assembly the console framework 14 into the dashboard framework 12, the console basket 40 is inserted into the opening 20. As this occurs, the guide surfaces 48 abut the groove guides 34 to insert the guide surfaces 48 into the guide grooves 32. Thus, the assembly worker can begin inserting the console framework 14 into the receiving opening 20. As the console is inserted into the dashboard framework 12, it is rotated downward to enable the guide pins 52 to insert into the dashboard apertures 38. As this occurs, the console framework 14 is pushed further into the opening 20. The middle guide pin 58 engages the recesses 36 to center the console framework 14 with respect to the dashboard framework 12. The dashboard walls 22, 24 includes a flange 60 to enable the bottom of the basket 40 to ride or slide into the opening 20.

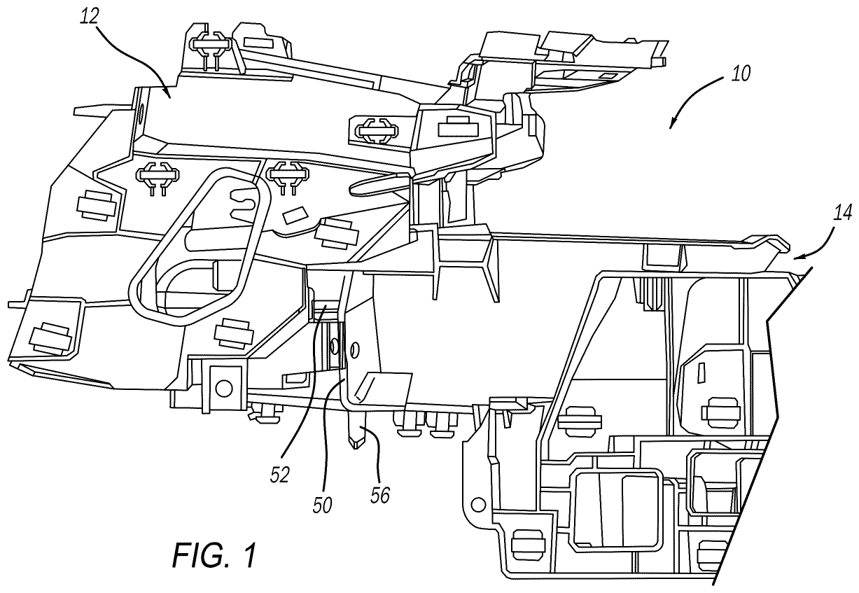

Once the basket is inserted into the opening 20, it is pushed inward until the stop 50 abuts the front of the walls 22, 24. At this time, the console framework 14 is rotated downward to position it onto the floor into its designated position. That is illustrated in FIG. 1. Thus, the console framework can be inserted into the dashboard opening 20 from a blind view of the assembly worker to couple the parts with one another.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle interior assembly comprising:
a dashboard framework having a receiving opening with two sidewalls, a pair of guide grooves, one groove on each side of the opening;
a console framework having a basket with a pair of sidewalls, a pair of guide surfaces, one guide surface projecting from each sidewall, the guide surfaces received by the guide grooves engaging the basket to be received in the opening; and
guide pins coupled with the basket for engaging aperture in the dashboard framework.

2. The vehicle interior assembly of claim 1, further comprising a pair of stops, one each adjacent the basket guide surface for contacting the dashboard framework for terminating insertion of the console framework into the receiving opening.

3. The vehicle interior assembly of claim 1, wherein the guide pins projects from each stop.

4. The vehicle interior assembly of claim 1, wherein flanges project from each sidewall of the opening for receiving a base of the basket.

5. The vehicle interior assembly of claim 1, wherein a middle guide pin is on a front wall of the basket for positioning the basket in the opening.

6. The vehicle interior assembly of claim 3, wherein the basket is rotated for alignment of the stop guide pins to be engaged into the apertures in the dashboard framework.

7. A method of connecting the dashboard framework and console framework of claim 1 comprising the steps of:
aligning the console guide surfaces in the dashboard guide grooves;
inserting the console guide surfaces partially into the guide grooves;
rotating the console;
aligning the guide pins; and
inserting, further, the console framework basket into the dashboard framework receiving opening.

8. The method of claim 7, further comprising inserting the guide pins into the apertures.

9. The method of claim 7, further comprising contacting the stops against the dashboard framework.

10. The method of claim 7, further comprising rotating the console downward into a designed position.
